(19) United States
(12) Patent Application Publication
(10) Pub. No.: US 2015/0178762 A1
(43) Pub. Date: Jun. 25, 2015

(54) LOCATION-BASED LOYALTY PROGRAM

(71) Applicant: Stephen La Point, Albany, NY (US)

(72) Inventor: Stephen La Point, Albany, NY (US)

(21) Appl. No.: 14/254,095

(22) Filed: Apr. 16, 2014

Related U.S. Application Data
(60) Provisional application No. 61/918,115, filed on Dec. 19, 2013.

(51) Int. Cl. G06Q 30/02

(52) U.S. Cl. CPC G06Q 30/0227

(57) ABSTRACT

Embodiments of the present invention provide a mobile location-based loyalty program. The frequent-driver program (FDP) and/or frequent-driving miles is a loyalty program (or any other name that might imply this type of mobile location based loyalty program) that may be offered by many business entities, referred to as ‘MERCHANTS’ and where customers, referred to as ‘USERS’ earn the reward points as they travel (The primary modes of travel include driving, walking, running or biking) through and/or stays within a reward region established by a ‘MERCHANT’. A reward region (overlay) pertains to a geographical area or areas. When a user travels through a reward region and/or remains within a reward region, the user has the opportunity to earn points that are redeemable with the merchant. Additionally, merchants have the opportunity to reach people that pass by and stay within the merchant reward regions (locations).

### CROSS-REFERENCE TO RELATED APPLICATION

This application is a non-provisional of, and claims the benefit of, U.S. patent application Ser. No. 61/918,115 filed Dec. 19, 2013, the entire contents of which are incorporated herein by reference.

### FIELD OF THE INVENTION

The present invention relates generally to loyalty programs, and more particularly, to mobile location-based loyalty programs.

### BACKGROUND

Loyalty programs are rewards programs offered by an entity such as a company, to customers who frequently make purchases. In some cases, a loyalty program may give a customer advanced access to new products, special sales coupons, or free merchandise. Customers typically provide some personal information with the company and are given a unique identifier, such as an account number and/or membership card, and use that identifier when making a purchase. An account is established to manage the earning and redeeming of points. Loyalty programs have become very popular in recent years. American consumers are estimated to maintain more than 2 billion loyalty program memberships, an average of 18 per household. While less than half are active, their combined point balances were worth close to $50 billion in 2010. With the widespread acceptance of loyalty programs by consumers, it is desirable to have improvements in loyalty programs.

### SUMMARY

Embodiments of the present invention provide a mobile location-based loyalty program. The frequent-driver program (FDP) and/or frequent-driving miles (FDM) are loyalty programs (or any other name that might imply this type of mobile location based loyalty program) that may be offered by many business entities, referred to as ‘MERCHANTS’ and where customers, referred to as ‘USERS’ earn the reward points as they travel (The primary modes of travel include driving, walking, running or biking) through and/or stays within a reward region established by a ‘MERCHANT’. A reward region (overlay) pertains to a geographical area or areas (geo-fencing). When a user travels through a reward region (overlay) and/or remains within a reward region (overlay), the user has the opportunity to earn points that are redeemable with the merchant. Additionally, merchants have the opportunity to reach people that pass by and/or stay within the merchant reward regions (Overlays).

In a first aspect, embodiments of the present invention provide a method for offering a user reward based on a visit to a specified location, comprising: establishing a reward region; establishing a point value for visiting the reward region; receiving a current location of a user; and awarding a number of points corresponding to the point value to the user in response to the user current location being co-located within the reward region.

In a second aspect, embodiments of the present invention provide a system for offering a user reward based on a visit to a specified location comprising: an administration server, configured and disposed to be in communication with a plurality of user devices, the administration server comprising a processor coupled to a memory, the memory containing machine instructions, that when executed by the processor, perform the steps of: receiving a current location of a user; comparing the user current location to a reward region; and awarding points to the user in response to the user current location being co-located within the reward region.

In a third aspect, embodiments of the present invention provide a computer program product embodied in a computer readable medium for implementation of a system for offering a user reward based on a visit to a specified location comprising machine instructions for: establishing a reward region; establishing a point value for visiting the reward region; receiving a user current location; and awarding to the user a number of points in response to the user current location being co-located within the reward region.

In a fourth aspect, embodiments of the present invention which provides a method for offering a user reward points based on the user remaining, visiting, and/or other criteria within a specified location, comprising: establishing a reward region; establishing a point value for remaining within this reward region for a duration of time, the number of visits, and/or a specific time period or other criteria that has been determined by the merchant.

### BRIEF DESCRIPTION OF THE DRAWINGS

FIG. 1 shows an example of a circular reward region in accordance with embodiments of the present invention.

FIG. 2 shows an example of a square reward region in accordance with embodiments of the present invention.

FIG. 3 shows an example of a user-defined reward region in accordance with embodiments of the present invention.

FIG. 4 shows an example of a route reward region in accordance with embodiments of the present invention.

FIG. 5 shows an example of a point reward region in accordance with embodiments of the present invention.

FIG. 6 shows an example of a reward region for multiple franchise locations in accordance with embodiments of the present invention.

FIG. 7 is a block diagram of an example of a system in accordance with embodiments of the present invention.

FIG. 8 is an example of a user interface for establishing overlay configuration (reward regions) in accordance with embodiments of the present invention.

FIG. 9 is an example of a user interface for overlay point configuration for a reward region in accordance with embodiments of the present invention.

FIG. 10 is an example of a user interface for offer configuration in accordance with embodiments of the present invention.

FIG. 11 is an example of a user interface for offer/overlay association in accordance with embodiments of the present invention.

FIG. 12 is a flowchart indicating process steps for embodiments of the present invention.

FIG. 13 is an example of a pre-offer in accordance with embodiments of the present invention.

FIG. 14 is an example of an offer in accordance with embodiments of the present invention.

FIG. 15 is an example of a gift bucket summary screen.

FIG. 16 is an example of a gift bucket details screen.

### DETAILED DESCRIPTION

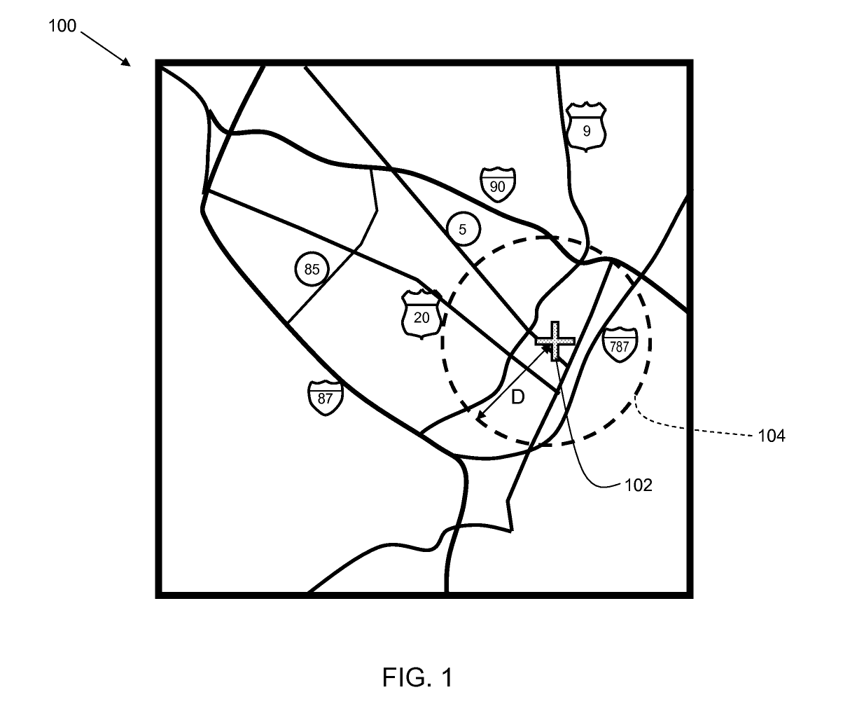

FIG. 1 shows a map 100 depicting a location of a merchant 102 with a circular reward region 104 having a diameter D, in accordance with embodiments of the present invention. In embodiments, the diameter D is a user-selectable value. In accordance with embodiments of the present invention, when a user travels within the boundary and/or stays within the boundaries of a reward region 104, the user may earn points which are credited towards a pre-established account. In embodiments, the user's device (e.g. the user devices may be smart phones, computers, tablets, personal digital assistants, or any other devices capable of transmitting location information to the server) is used to report the current location to an administration server. These devices typically have a location reporting capability in them, via a satellite based system such as Global Positioning System (GPS), or the like. Additionally, location based on cellular signal triangulation, WiFi, or other suitable signals may also be used to further enhance the location reporting.

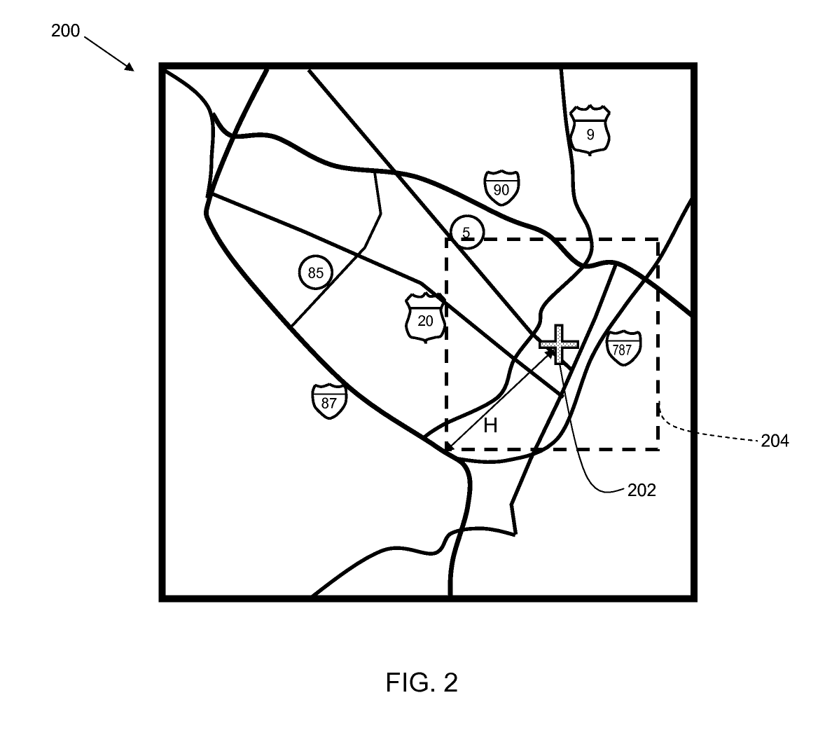

FIG. 2 shows a map 200 depicting a location of a merchant 202 with a square reward region 204 having a diagonal H, in accordance with embodiments of the present invention. The diagonal H extends from the location of the merchant 202 to a corner of the square reward region 204. In embodiments, the diagonal H is a user-selectable value. Regardless of the shape of the reward region, the point-earning mechanism is similar. So, any suitable shape of reward region is included within the scope of the invention.

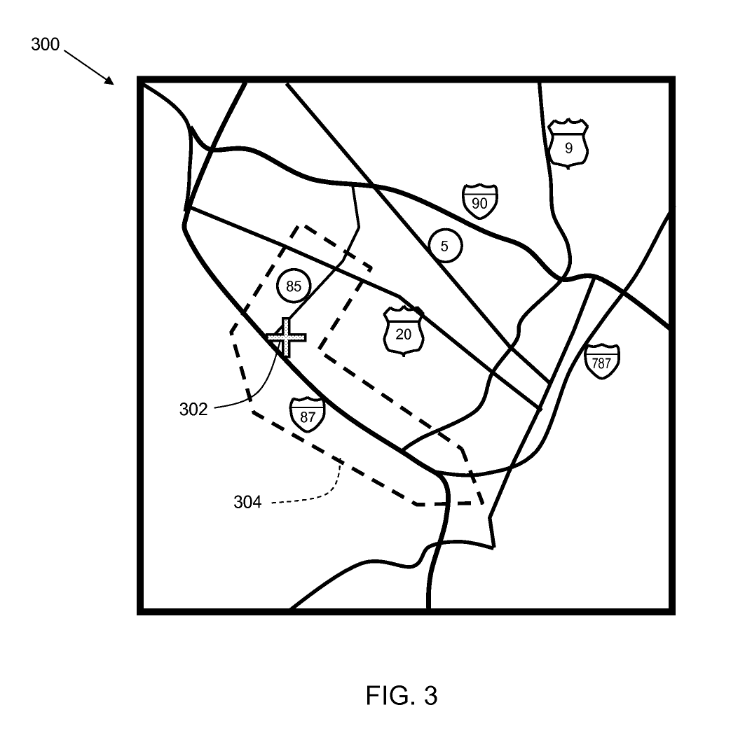

FIG. 3 shows a map 300 depicting a location of a merchant 302 with a user-defined reward region 304. In embodiments, the user-defined reward region may be formed by drawing segments on a map to form a closed shape. For the example shown in FIG. 3, a merchant may wish to award points to users that travel along a portion of route 87 or a portion of route 85 and/or stays within the boundaries of a reward region that is encompassed by (co-located within) the user-defined reward region 304. In embodiments, a merchant may define a user-defined reward region by drawing it on a computer-generated map.

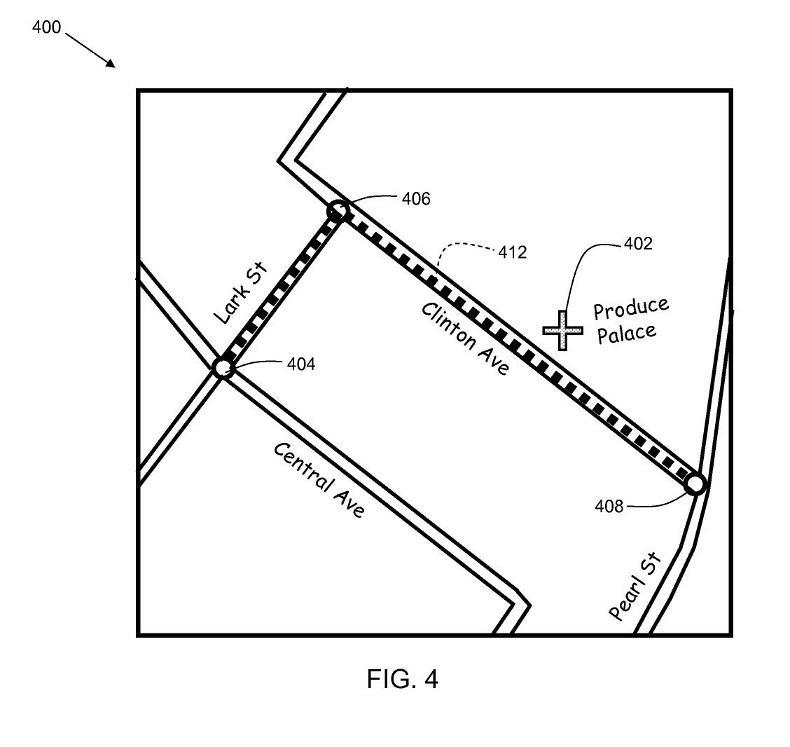

FIG. 4 shows a map 400 depicting a location of a merchant 402 with a route reward region 412. In embodiments, the route reward region may be formed by drawing points (404, 406, and 408) and connecting these points together on a map to form a route. For the example shown in FIG. 4, a merchant may wish to award points to users that travel along a portion of the route and/or stays within the boundaries of an reward region that is encompassed by (co-located within) the route reward region 412. In embodiments, a merchant may define a route reward region by drawing it on a computer-generated map.

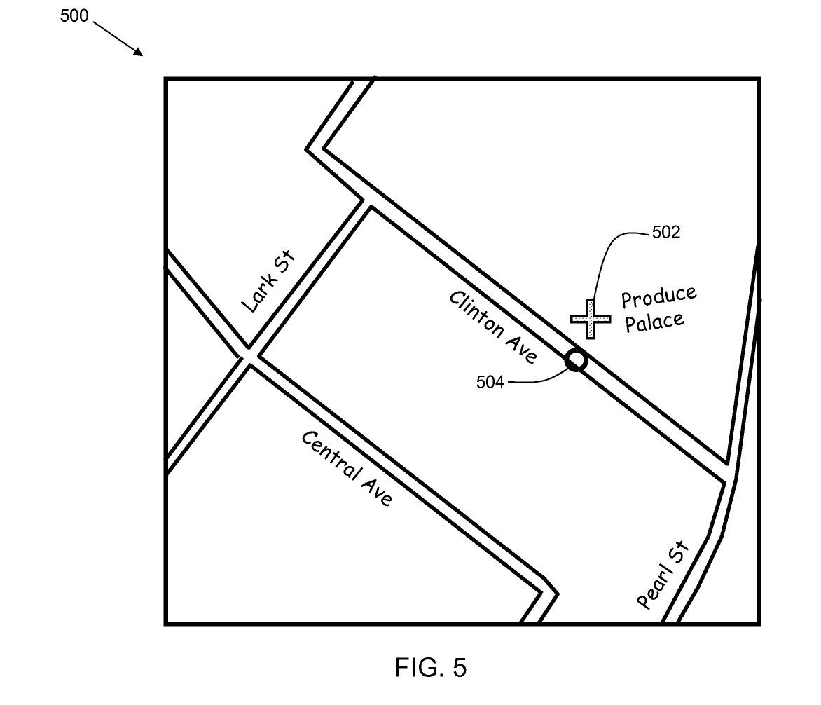

FIG. 5 shows a map 500 depicting a location of a merchant 502 with a point reward region 504. In embodiments, the point reward region may be formed by drawing a point on a map to form a point. For the example shown in FIG. 5, a merchant may wish to award points to users that travel through the point and/or stays within the boundaries of a point that is encompassed by (co-located within) the point reward region 504. In embodiments, a merchant may define a point reward region by drawing it on a computer-generated map.

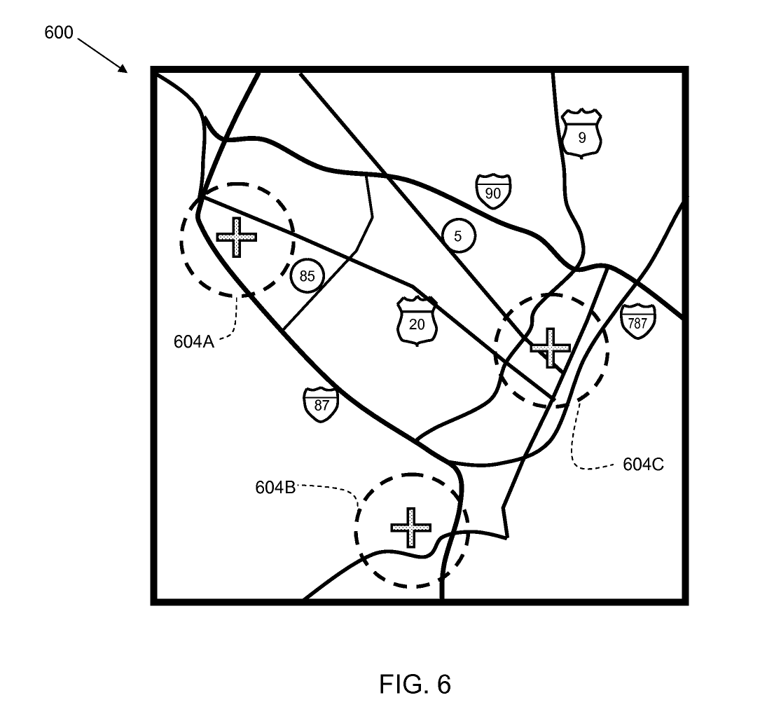

FIG. 6 shows a map 600 depicting a reward region for multiple franchise locations in accordance with embodiments of the present invention. As shown in FIG. 4, three reward regions 604A, 604B, and 604C are defined. In embodiments, each reward region may correspond to a franchise location (or other type of location, such as a headquarters, store location, or competitor's locations, etc.) for the merchant. For example, if a business has three locations, and if a user travels within any of the reward regions 604A, 604B, or 604C and/or stays within the boundaries of any reward region, points corresponding to that merchant can be earned by the user.

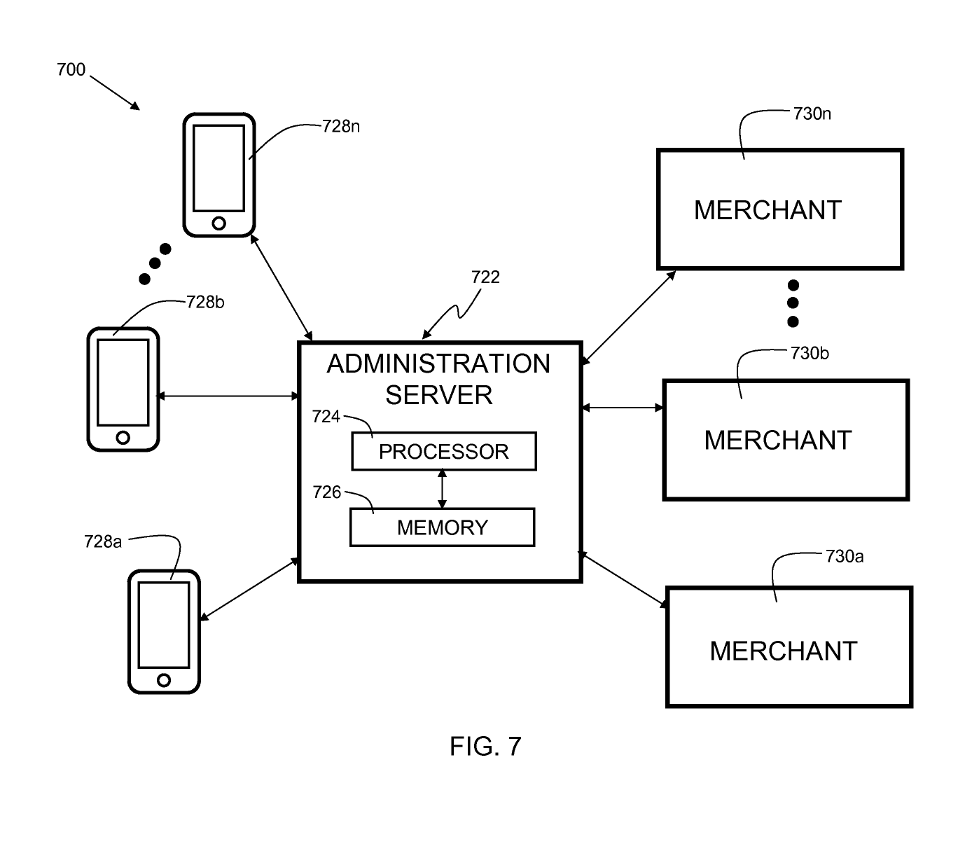

FIG. 7 is a block diagram of a system 700 in accordance with embodiments of the present invention. An administration server 722 is a computer comprising processor 724 and memory 726. Memory 726 is a computer readable storage medium, and may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, any suitable combination of the foregoing, and/or any other suitable mechanism.

The administration server 722 is in communication with a plurality of user devices 728a-728n. The user devices may be smart phones, computers, tablets, personal digital assistants, or any other mobile devices capable of transmitting location information to the administration server 722. In embodiments, the administration server is connected to the Internet. The administration server may also provide web-based logins (e.g. via an http server such as Apache, Linux, Unix, IBM or Windows servers), such that a plurality of merchants 730a-730n may establish accounts, offers, and rules for earning points. Similarly, users may log in to establish accounts and check point balances.

The administration server 722 implements point earning rules established by each merchant. The rules may include, but are not limited to, how many points are earned upon entry into the reward zone. Additionally, the rules may include awarding an extended stay point bonus in response to the user's current location being located within the reward region for a predefined continuous duration. For example, if the user stays within the reward region for 2 hours, they may earn an extra 50 points. Additionally, the rules may include awarding a frequent visit point bonus in response to the user current location being located within the reward region for a specified number of times in a predetermined duration. For example, if the user visits the reward region five times within a one week period, they may earn an extra 50 points. Additionally, the rules may include awarding a special period point bonus in response to the user current location being located within the reward region during a predetermined time. For example, if the user visits the reward region on a Monday between the hours of 3:00 pm and 5:00 pm, they may earn an extra 50 points. This type of reward can serve to draw business during hours that are typically slow for a merchant and can furthermore be used by the merchant to identify the location patterns of users in and around their businesses.

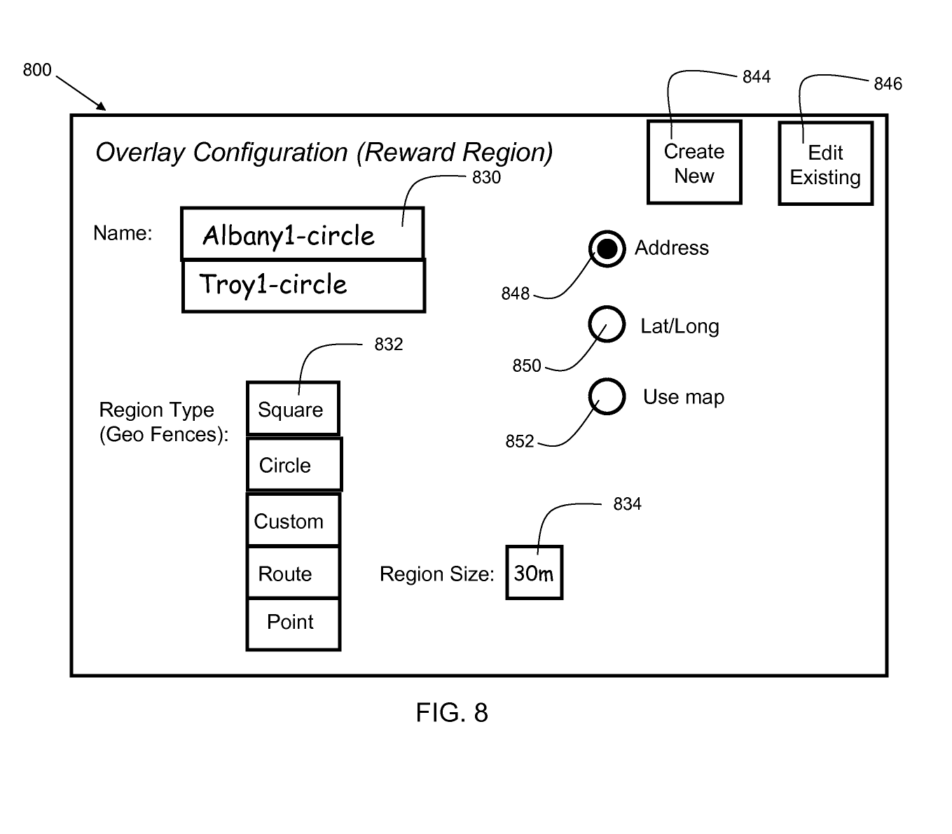

FIG. 8 is an example of a user interface 800 for establishing an Overlay Configuration (Reward Region) in accordance with embodiments of the present invention. In embodiments, the user interface 800 and others within this disclosure may be rendered as an HTML page on a web browser such as Internet Explorer, Mozilla, or the like. Field 830 provides for entry or selection of a name of an overlay. In embodiments, the Overlay may represent any one of the types of reward regions being defined by the merchant. In embodiments, field 830 may include a list box or other selection mechanism to browse through existing overlay names and select them for editing. Field 832 provides for selection of a reward region type. In embodiments, the type selected may be square (as shown in FIG. 2), circle (as shown in FIG. 1), or user-defined (custom), as shown in FIG. 3. Additionally, a route may be defined as shown in FIG. 4, or a point may be defined as shown in FIG. 5. In the case of a square or circle reward region, the user enters or selects a region size in field 834. The units may be in miles, kilometers, meters, or any other suitable unit of measurement. If the user selects custom, route, or point, then the user may define the region, by for example, without limitation, drawing the region on a map display, to define a region such as 304 shown in FIG. 3. It should be recognized that user interface 800 is a non-limiting example. Button 844 allows creation of a new overlay. Button 846 allows for selection of an existing overlay to edit. One or more positional options may be present to provide for the positioning of the overlay. Address option 848 allows the user to enter an address as the center of the overlay. Lat/Long option 850 allows the user to specify latitude and longitude coordinates for the center of the overlay. Use map option 852 allows a user to select a position for the overlay by clicking on a computer-generated map. In practice, more, fewer, or other features/information may be displayed, and/or in a different visual display configuration. A list will be provided of all overlays created so it may be selected and edited to adjust each reward region created.

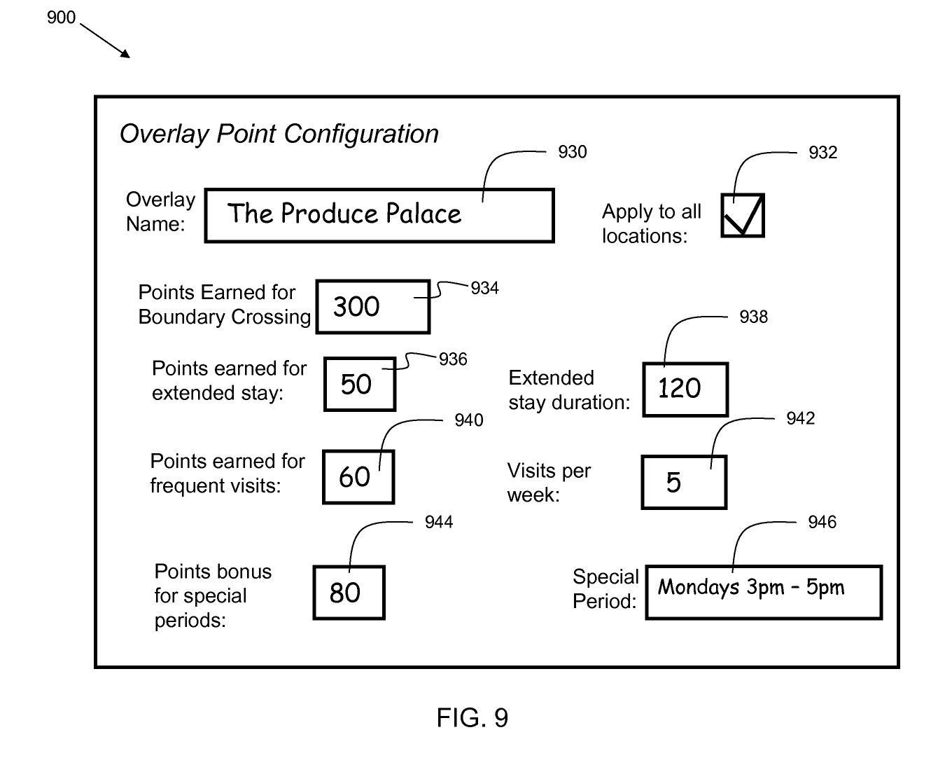

FIG. 9 is an example of a user interface 900 for Overlay Point Configuration in accordance with embodiments of the present invention. Field 930 provides for entry of an overlay name/identifier. Field 932 is a checkbox to indicate if the rules established in user interface 900 are to apply to all locations of the merchant (e.g. all franchise locations). For example, in FIG. 4, three franchise locations are indicated, each with their own reward region. With embodiments of the present invention, it is possible to apply the rules to all reward regions. In field 934, the number of points the user earns for entering a reward region is entered. In field 936, the number of points the user earns for an extended stay in a reward region is entered. In field 938, the duration of the extended stay is defined. In this example, if the user stays in a reward region for 120 minutes, an additional 50 points is earned. In field 940, the number of points the user earns for frequent visits is entered. In field 942, the number of visits in a given duration to qualify as “frequent” is defined. In this example, if the user visits a reward zone five times within one week, an additional 60 points is earned. In field 944, the number of points the user earns for visiting during a special period is entered. In field 946, the special period is defined. In this example, if the user visits a reward zone on a Monday between the hours of 3:00 pm and 5:00 pm, an additional 80 points is earned. It should be recognized that user interface 900 is a non-limiting example. In practice, more, fewer, or other features/information may be displayed, and/or in a different visual display configuration.

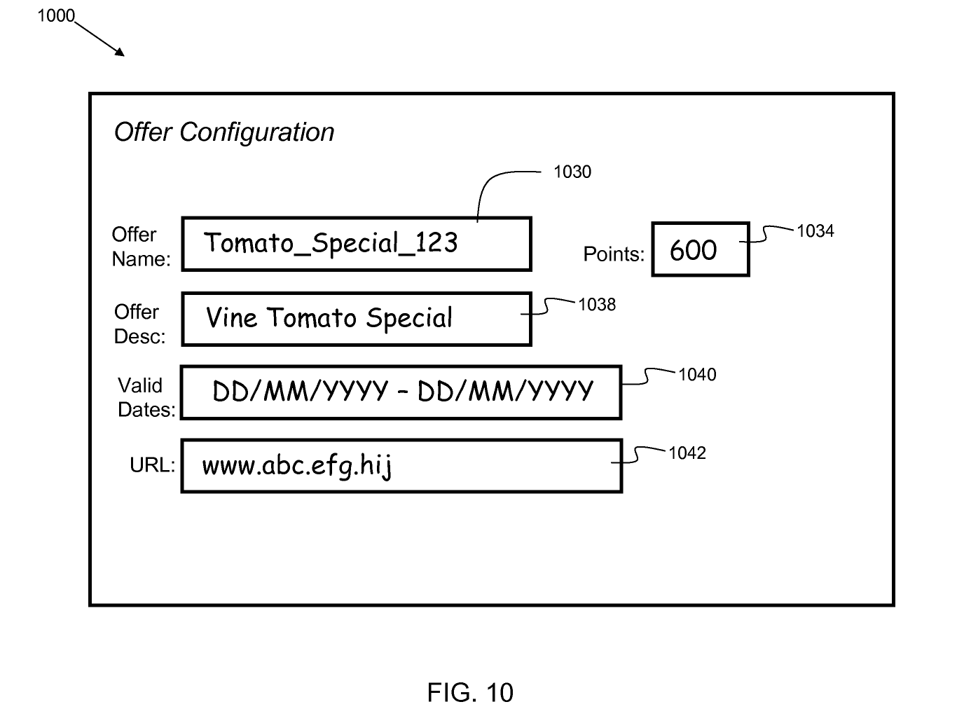

FIG. 10 is an example of a user interface 1000 for Offer Configuration in accordance with embodiments of the present invention. Field 1030 provides for entry of an offer name/identifier. In field 1034, the number of points required for a user to receive this offer is defined. In field 1038, a description for the offer is entered. In field 1040, a start and end validity date for the offer are entered. In field 1042, a uniform resource locator (url) pointing to additional text and/or graphic elements (e.g. such as a jpeg image) is entered. It should be recognized that user interface 1000 is a non-limiting example. In practice, more, fewer, or other features/information may be displayed, and/or in a different visual display configuration.

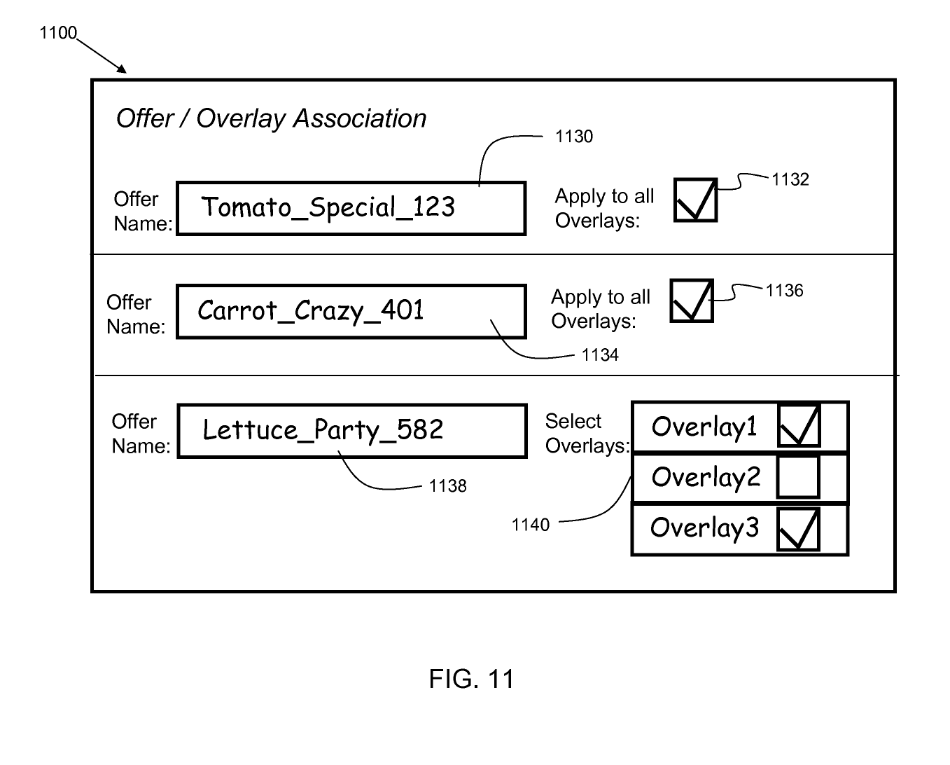

FIG. 11 is an example of a user interface 1100 for Offer/Overlay Association in accordance with embodiments of the present invention. In this example, three offers are shown. For offer 1130, a corresponding checkbox 1132 is checked, indicating that the offer 1130 (Tomato_Special_123) is offered at all Overlays. Similarly, for offer 1134, a corresponding checkbox 1136 is checked, indicating that the offer 1134 (Carrot_Crazy_401) is offered at all Overlays. For offer 1138 (Lettuce_Party_582), the “Apply to All Overlays” checkbox is unchecked, causing the individual Overlay selection box 1140 to appear. In this example, the offer 1138 is available at Overlay Name 1 and Overlay Name 3, but not at Overlay Name 2. In this way, a merchant can target certain locations with specific offers to help promote the sale of excess inventory at certain locations, while not running those offers at locations that do not have the excess inventory. It should be recognized that user interface 1100 is a non-limiting example. In practice, more, fewer, or other features/information may be displayed, and/or in a different visual display configuration.

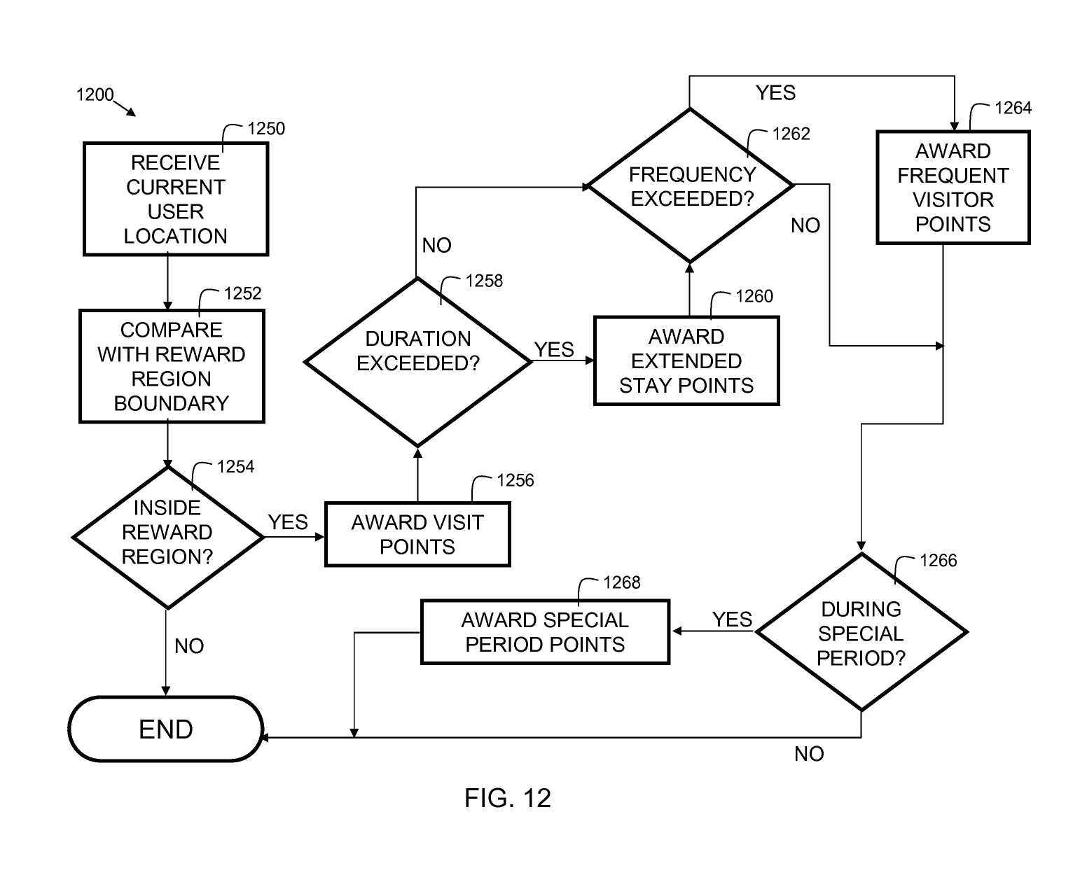

FIG. 12 is a flowchart 1200 indicating process steps for embodiments of the present invention. In process step 1250, a current user location is received, by the administration server along with a unique identifier, such as a phone number or account number. In embodiments, an application running on the user's mobile device may periodically transmit the current user location and unique identifier to the administration server. The location is checked in process step 1252 to see if it is encompassed by any reward region (overlays) in process step 1254. If the user location is deemed to be inside the reward region in process step 1254, then, as the administration server has the information about which user has entered the reward zone, it awards the visit points in process step 1256. If no, then the process ends. After awarding visit points, the administration server next checks if a duration is exceeded in process step 1258. If yes, then extended stay points are awarded in process step 1260. If no, then the process proceeds to check if the frequency of visits is exceeded in process step 1262. If yes, then frequent visitor points are awarded in process step 1264. If no, then the process proceeds to check if the visit is during a special period in process step 1266. If yes, then special period points are awarded in process step 1268. If no, then the process ends. It should be recognized that flowchart 1200 is a non-limiting example. In practice, more, fewer or other steps may be included, and/or the steps may be performed in an order different from that disclosed.

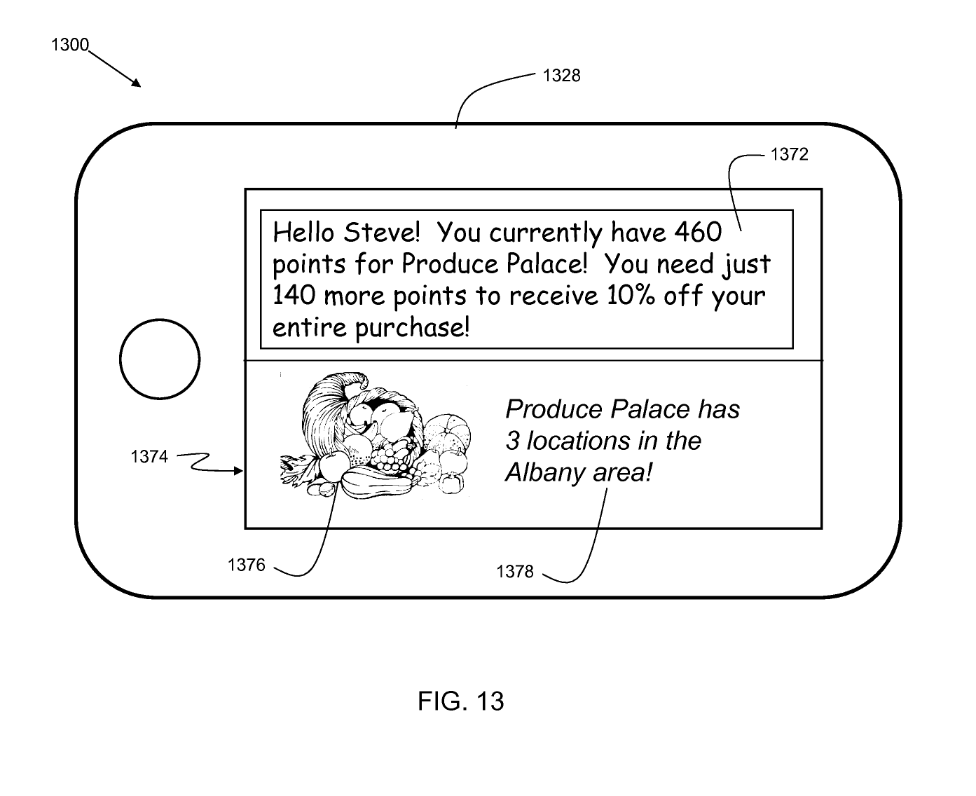

FIG. 13 is an example of a pre-offer 1300 in accordance with embodiments of the present invention. In embodiments of the present invention, when the administration server confirms entry of a user into a reward zone (e.g. the entry into process step 1256 of FIG. 12), a check is made on the current point balance of the user. If the user's current point balance is below what is needed to earn an offer, then a pre-offer as shown in FIG. 13 may be sent to the user's mobile device 1328 or other suitable device. The pre-offer may contain text 1372 which presents the user's current point balance, and how many more points are needed to earn an offer. An additional information field 1374 may contain graphic elements 1376 and/or additional text elements 1378 providing more information about the merchant and/or offer. It should be recognized that the elements (1372, 1374, 1376, and 1378) of the pre-offer are examples. In practice, more, fewer, or other features/information may be displayed, and/or in a different visual display configuration. In this way, the pre-offer provides motivation for the user to continue to return to, or remain in, the reward zone, given the prospect of earning enough points for an offer.

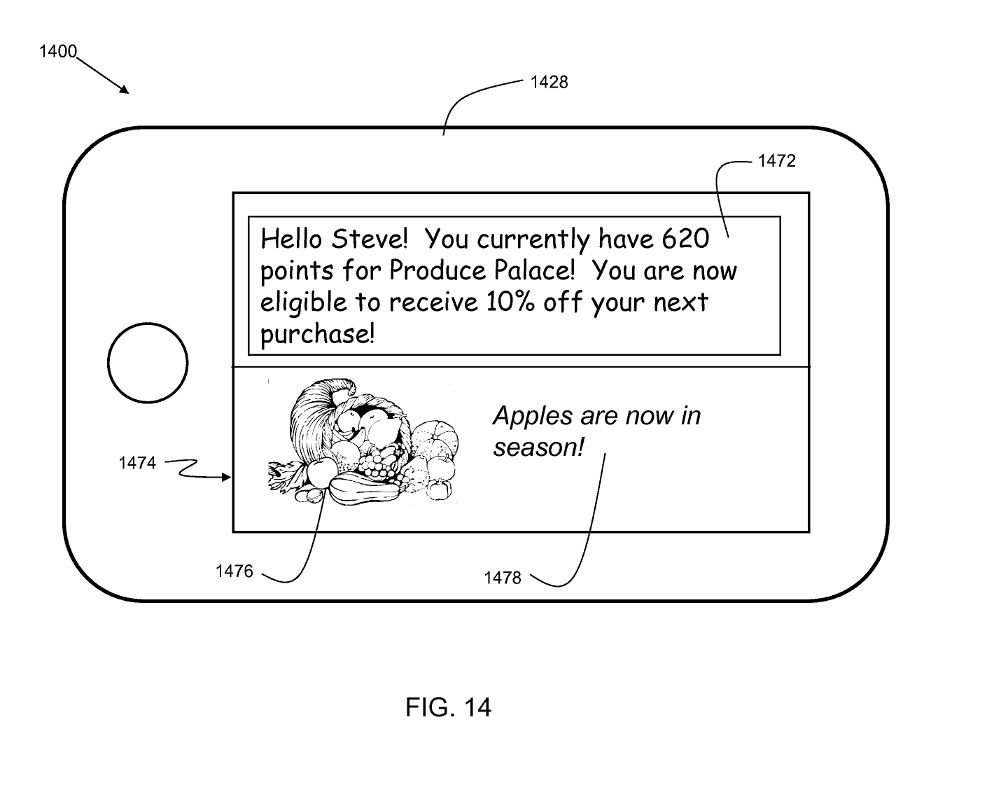

FIG. 14 is an example of an offer 1400 in accordance with embodiments of the present invention. In embodiments of the present invention, when the administration server confirms entry of a user into a reward zone (e.g. the entry into process step 1256 of FIG. 12), a check is made on the current point balance of the user. If the user's current point balance is sufficient to earn an offer, then an offer as shown in FIG. 14 may be sent to the user's mobile device 1428 or other suitable device. The offer may contain text 1472, which presents the user's current point balance and details of the offer. An additional information field 1474 may contain graphic elements 1476 and/or additional text elements 1478 providing more information about the merchant and/or offer. It should be recognized that the elements (1472, 1474, 1476, and 1478) of the offer are examples. In practice, more, fewer, or other features/information may be displayed, and/or in a different visual display configuration.

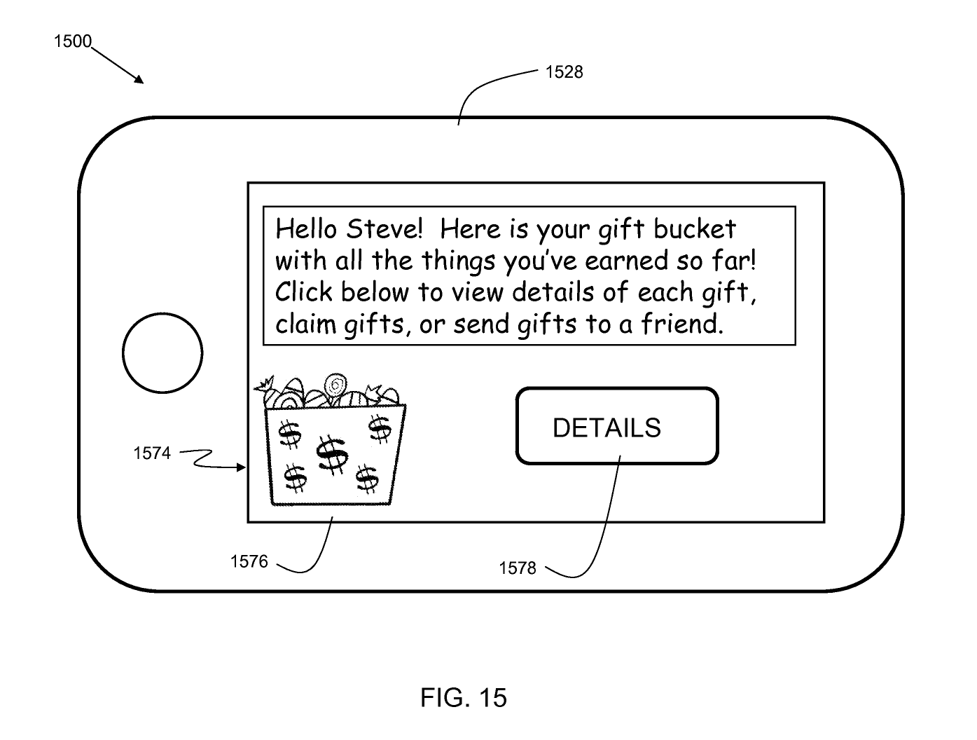

FIG. 15 is an example of a gift bucket summary screen 1500 in accordance with embodiments of the present invention. The concept of the gift bucket is a reward earnings summary that contains unredeemed gifts that a user has earned from all of the merchants he has earned points with. The use of the gift bucket enables the user to claim a gift and start a new relationship with the merchant or claim a gift from a merchant whom they already have confirmed a relationship with. The user has an option to approve the relationship between themselves and a particular merchant (e.g. to be on a mailing list for that merchant). The user can also give any gift away to anyone by emailing them the gift or printing out the gift coupon and giving it to a friend, family member or anyone whom they choose to give it to. In this way, embodiments of the present invention facilitate word of mouth advertising on behalf of the merchant whom they choose to give away any gift that they have earned or redeemed. The gift bucket summary may be displayed on the user's mobile device 1528 or other suitable device. Information field 1574 may contain graphic elements 1576 and/or button 1578 to access the details of the reward earnings summary. It should be recognized that the elements (1574, 1576, and 1578) of the screen are examples. In practice, more, fewer, or other features/information may be displayed, and/or in a different visual display configuration.

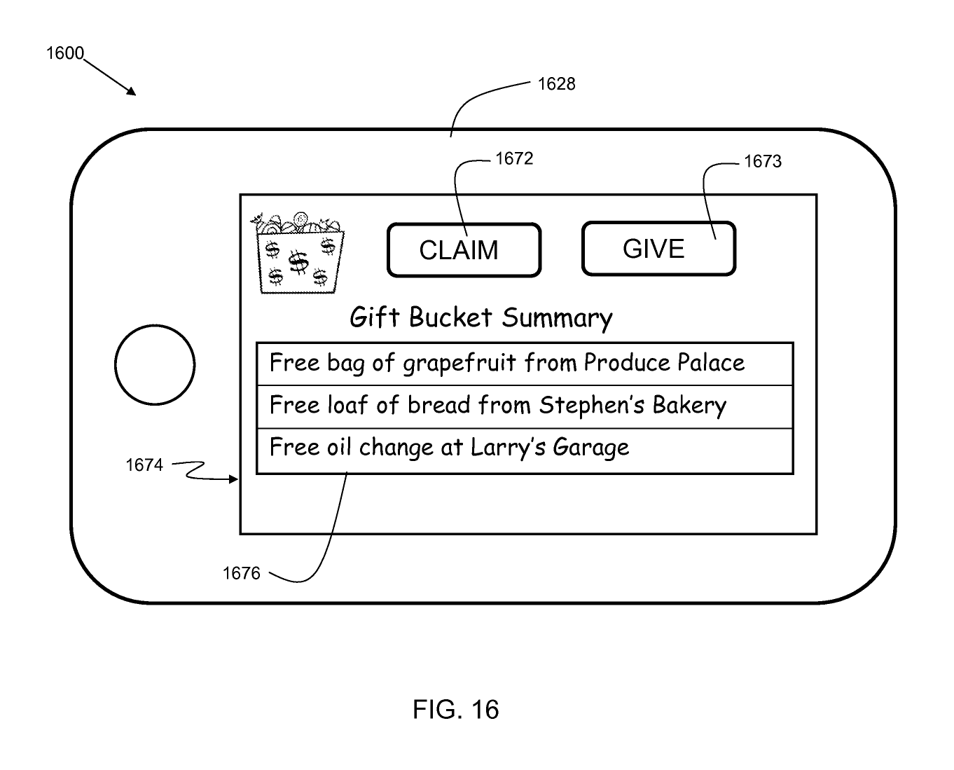

FIG. 16 is an example of a gift bucket details screen 1600. The gift bucket details may be displayed on the user's mobile device 1628 or other suitable device. Information field 1674 may contain a list 1676 of the current rewards/gifts earned from different merchants. Claim button 1672 enables a user to claim a selected gift. When the user presses the claim button 1672, they may be redirected to the merchant website to receive a coupon. If necessary, the user may be prompted for additional information, and asked to agree to terms and conditions in order to redeem the gift. When the user presses the give button 1672, they may be redirected to their e-mail and/or text message screen to send a selected gift or gifts to another person. The recipient then receives an email or text message with the gift details so that they may redeem it. It should be recognized that the elements (1672, 1674, and 1676) of the screen are examples. In practice, more, fewer, or other features/information may be displayed, and/or in a different visual display configuration.

As can now be appreciated, embodiments of the present invention provide an improved mobile loyalty program based on location. Embodiments of the present invention provide a loyalty program developed using mobile technologies such as ‘location based awareness’ and ‘geo-fence’ overlays (reward region) concepts to encourage user loyalty towards the merchants and in turn, enable users to receive benefits offered by the merchants. The users earn the loyalty points based on their location, that is, when they pass by or stay within the ‘geo-fence’ marked by the merchants on their stores/facility. After a predetermined number of points have been accumulated by the users for a merchant's loyalty program or programs, they can take advantage of the offers/discounts/gifts offered by the merchant.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, circuits, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

What is claimed is:

1. A method for offering a user reward based on a visit to a specified location, comprising:
establishing a reward region;
establishing a point value for visiting the reward region;
receiving a current location of a user; and
awarding a number of points corresponding to the point value to the user in response to the user current location being co-located within the reward region.

2. The method of claim 1, further comprising:
establishing multiple reward regions, each reward region corresponding to a franchise location for a merchant; and
awarding a number of points corresponding to the point value to the user in response to the user current location being co-located within any one of the multiple reward regions.

3. The method of claim 1, wherein establishing a reward region comprises establishing a circular reward region.

4. The method of claim 1, wherein establishing a reward region comprises establishing a square region.

5. The method of claim 1, wherein establishing a reward region comprises establishing a user-defined closed shape.

6. The method of claim 1, wherein establishing a reward region comprises establishing a route region.

7. The method of claim 1, wherein establishing a reward region comprises establishing a point region.

8. The method of claim 1, further comprising awarding an extended stay point bonus in response to the user current location being located within the reward region for a predefined continuous duration.

9. The method of claim 1, further comprising awarding a frequent visit point bonus in response to the user current location being located within the reward region for a specified number of times in a predetermined duration.

10. The method of claim 1, further comprising awarding a special period point bonus in response to the user current location being located within the reward region during a predetermined time.

11. A system for offering a user reward based on a visit to a specified location comprising:
an administration server, configured and disposed to be in communication with a plurality of user devices, the administration server comprising a processor coupled to a memory, the memory containing machine instructions, that when executed by the processor, perform the steps of:
receiving a current location of a user;
comparing the user current location to a reward region; and
awarding points to the user in response to the user current location being co-located within the reward region.

12. The system of claim 11, wherein the memory further comprises machine instructions, that when executed by the processor, perform the steps of:
establishing multiple reward regions, each reward region corresponding to a franchise location for a merchant; and
awarding to the user a number of points in response to the user current location being co-located within any one of the multiple reward regions.

13. The system of claim 11, wherein the memory further comprises machine instructions, that when executed by the processor, perform the step of establishing a user-defined closed shape reward region.

14. The system of claim 11, wherein the memory further comprises machine instructions, that when executed by the processor, perform the step of awarding an extended stay point bonus in response to the user current location being located within the reward region for a predefined continuous duration.

15. The system of claim 11, wherein the memory further comprises machine instructions, that when executed by the processor, perform the step of awarding a frequent visit point bonus in response to the user current location being located within the reward region for a specified number of times in a predetermined duration.

16. The system of claim 11, wherein the memory further comprises machine instructions, that when executed by the processor, perform the step of awarding a special period point bonus in response to the user current location being located within the reward region during a predetermined time.

17. A computer program product embodied in a computer readable medium for implementation of a system for offering a user reward based on a visit to a specified location comprising machine instructions for:
establishing a reward region;
establishing a point value for visiting the reward region;
receiving a user current location; and
awarding to the user a number of points in response to the user current location being co-located within the reward region.

18. The computer program product of claim 17, further comprising machine instructions for awarding an extended stay point bonus in response to the user current location being located within the reward region for a predefined continuous duration.

19. The computer program product of claim 17, further comprising machine instructions for awarding a frequent visit point bonus in response to the user current location being located within the reward region for a specified number of times in a predetermined duration.

20. The computer program product of claim 17, further comprising machine instructions for awarding a special period point bonus in response to the user current location being located within the reward region during a predetermined time.
